(19) United States
(12) Patent Application Publication
(10) Pub. No.: US 2010/0331037 A1
(43) Pub. Date: Dec. 30, 2010

(54) Method and Related Communication Device for Enhancing Power Control Mechanism

(76) Inventor: Yu-Chih Jen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/822,194

(22) Filed: Jun. 24, 2010

Related U.S. Application Data
(60) Provisional application No. 61/219,778, filed on Jun. 24, 2009.

(51) Int. Cl. H04W 52/04

(52) U.S. Cl. 455/522

(57) ABSTRACT

A method for enhancing power control mechanism for a mobile device in a wireless communications system includes enabling a repetition function by which the mobile device repeatedly transmits a feedback signal in a plurality of consecutive subframes, receiving downlink signaling indicating an uplink grant as well as a power control command and allocation of a subframe of an uplink transmission, and not performing the uplink transmission in the subframe when the subframe collides with one of the consecutive subframes.

### CROSS REFERENCE TO RELATED APPLICATIONS

This application claims the benefit of U.S. Provisional Application No. 61/219,778, filed on Jun. 24, 2009 and entitled “Method and Apparatus for power control enhancement”, the contents of which are incorporated herein in their entirety.

### BACKGROUND OF THE INVENTION

1. Field of the Invention

The present invention relates to a method used in a wireless communications system and related communication device, and more particularly, to a method for enhancing power control mechanism in a wireless communications system and related communication device.

2. Description of the Prior Art

A long-term evolution (LTE) system, initiated by the third generation partnership project (3GPP), is now being regarded as a new radio interface and radio network architecture that provides a high data rate, low latency, packet optimization, and improved system capacity and coverage. In the LTE system, a radio access network known as an evolved universal terrestrial radio access network (E-UTRAN) includes a plurality of evolved Node-Bs (eNBs) for communicating with a plurality of user equipments (UEs) and communicates with a core network including a mobility management entity (MME), serving gateway, etc for NAS (Non Access Stratum) control. A long term evolution-advanced (LTE-A) system, as its name implies, is an evolution of the LTE system, with carrier aggregation and relay deployment. The carrier aggregation allows a UE of the LTE-A system to simultaneously transmit and receive data via multiple carriers, where the UE of the LTE system can only utilize one carrier for data transmission at any time.

A relay node in the LTE-A system is considered to improve the coverage of high data rates, group mobility, temporary network deployment, the cell-edge throughput and to extend coverage. The relay can be deployed at the cell edge where the eNB may be unable to provide required radio quality/throughput for the UEs that shall be served by the eNB or at certain location where radio signals of the eNB may not cover.

A physical downlink control channel (PDCCH) is used to carry a message known as Downlink Control Information (DCI) with certain DCI format, which includes resource assignments and other control information, e.g. a transmission power control (TPC) command and a uplink grant including a physical uplink shared channel (PUSCH) related information, for a UE or group of UEs.

In the LTE system, the UE may adjust transmission power of an uplink transmission of a PUSCH according to the TPC command of the PDCCH signaling. In addition, the uplink grant indicating what subframe and other resources the UE needs to use to perform the uplink transmission of the PUSCH. However, the indicated subframe and subframes for ACK/NACK (Acknowledgement/Negative Acknowledgement) response to later PDSCH reception may be collided with subframes of an ACK/NACK repetition period which is for ACK/NACK response to an earlier PDSCH reception.

The ACK/NACK repetition period is used for an acknowledgement/negative acknowledgement (ACK/NACK) repetition that is introduced to the LTE system in order to increase the probability of correct hybrid automatic repeat request (HARQ) feedback signal detection. The UE can detect a PDSCH transmission carrying data packets and thereby needs to report an ACK if the packet data of the PDSCH transmission is successfully received and decoded or to report a NACK if the packet data is failed in reception or decoding. The UE enabling the ACK/NACK repetition is allowed to repeatedly transmit the ACK or NACK in a number of consecutive subframes that are regarded as the ACK/NACK repetition period.

Thus, in the abovementioned colliding situation, the UE may not perform the uplink transmission and ACK/NACK response to later PDSCH reception, and do not know how to deal with related TPC command and transmission counter for redundancy versions according to the LTE/LTE-A specifications. Adjusting the transmission power to an unexpected high level can cause interference to other UEs. Adjusting the transmission power to an unexpected low level can cause failure of the uplink transmission. Using wrong redundancy version can cause unsuccessful decoding due to wrong combining.

In addition, according to the LTE system, the whole power control mechanism is designed for a serving base station/cell since the UE in the LTE system normally can communicate with one serving base station/cell, unlike the soft handover case in UMTS. In the LTE-A system, the UE may transmit/receive multiple transmissions from more than one component carrier, cell, or access point, e.g. CoMP or even both relay and base station together. In LTE, each cell consists of one component carrier while UE in LTE-A may operates on multiple component carriers to one or more cells. Currently, there is no mechanism to deal with UL power control of the LTE-A UE with connections to multiple component carriers or multiple geographically separated antenna ports, access points or cells where channel conditions (e.g. interference level) and distances are different among component carriers or cells (e.g. pathloss characteristics, cell coverage, power control parameters, and interference control are all different among cells). Thus, if the LTE-A UE follows the LTE power control rules, all of transmissions corresponding to different component carriers or access points are always applied with the same power control configuration as the serving access point. However, the power control configuration for the donor component carrier or serving access point may not accurately reflect the communication environment of other component carriers or access points, thereby resulting in the abovementioned interference problem or transmission failure.

Furthermore, the relay may be transparent or non-transparent to the UE. This may lead the UE to be under coverage/control as below: (1) under control of the relay; (2) under control of the base station and under coverage of the relay; (3) under control of the base station and not under coverage of the relay. Thus, the UE may simultaneously has connections with the relay and the base station, and no power control mechanism to define how the transmit power control of the UE under those coverage/control situation.

### SUMMARY OF THE INVENTION

The disclosure therefore provides a method and related communication device for enhancing power control mechanism, which allows a mobile device capable of simultaneous transmission and reception with multiple communication signal sources to recognize which communication signal source a received power control configuration(s) corresponds to and to accurately apply the power control configuration(s) on corresponding communication signal source(s), so that the power control can be flexible and adaptive to different connections with the communication signal sources.

A method for enhancing power control mechanism for a mobile device in a wireless communications system is disclosed. The method includes enabling a repetition function by which the mobile device repeatedly transmits a feedback signal in a plurality of consecutive subframes, receiving downlink signaling indicating an uplink grant as well as a power control command and allocation of a subframe of an uplink transmission, and not performing the uplink transmission in the subframe when the subframe collides with one of the consecutive subframes.

A method for enhancing power control mechanism for a network in a wireless communications system is disclosed. The method includes sending to a mobile device downlink signaling indicating an uplink grant as well as a power control command and allocation of a subframe of a first uplink transmission, and determining that the mobile device applies the power control command, when the first uplink transmission is not performed in the subframe.

A method for enhancing power control mechanism for a mobile device capable of simultaneously communicating through a plurality of radio resources or with a plurality of communication signal sources in a wireless communications system is disclosed. The method includes receiving at least a set of downlink control information each having a format, and determining a corresponding relationship between the at least a set of downlink control information and the plurality of radio resources or between the at least a set of downlink control information and the plurality of communication signal sources, according to at least one of corresponding format, at least a time-frequency channel corresponding to a communication signal source or a radio resource for the reception of the downlink control information, and content of the downlink control information.

A method for enhancing power control mechanism for a mobile device capable of simultaneously communicating through a plurality of radio resources or with a plurality of communication signal sources in a wireless communications system is disclosed. The method includes storing a plurality sets of parameter values for power control configuration, wherein each set of parameter values corresponds to one of the plurality of radio resources or the plurality of communication signal sources, and performing power control for at least a connection established with each of the plurality of communication signal sources or on each of the plurality of radio resources, according to corresponding set of parameter values.

A method for enhancing power control mechanism for a mobile device capable of simultaneously communicating through a plurality of radio resources or with a plurality of communication signal sources in a wireless communications system is disclosed. The method includes receiving first downlink control information on a signaling channel for transferring control plane data, receiving second downlink control information on a data channel for transferring user plane data, performing power control of at least a connection established with a dominant communication signal source dominating the rest of communication signal sources or on a radio resource dominating the rest of radio resources, according to the first downlink control information, and performing power control of at least a connection established with one of the communication signal sources or on one of the radio resources according to the second downlink control information.

A method for enhancing power control mechanism for a mobile device capable of simultaneously communicating through a plurality of radio resources or with a plurality of communication signal sources in a wireless communications system is disclosed. The method includes obtaining a corresponding relationship between at least one radio network temporary identifier (RNTI) and the plurality of radio resources or between the at least one RNTI and the plurality of communication signal sources, detecting and receiving downlink control information addressed to a first RNTI of the at least one RNTI, determining that the first RNTI of the at least one RNTI corresponds to at least a first radio resource or communication signal source of the plurality of radio resources or communication signal sources according to the corresponding relationship, and performing power control of at least a transmission or at least a connection established on the at least a first radio resource or with the at least a first communication signal source according to the received downlink control information corresponding to the at least a first radio resource or the at least a first communication signal source.

A method for enhancing power control mechanism for a mobile device capable of simultaneously communicating through a plurality of radio resources or with a plurality of communication signal sources in a wireless communications system is disclosed. The method includes obtaining a corresponding relationship between a plurality of RNTIs and the plurality of radio resources or between the plurality of RNTIs and the plurality of communication signal sources, detecting and receiving the downlink control information addressed to a first RNTI, determining that the first RNTI corresponds to a first radio resource or communication signal source according to the corresponding relationship, and performing power control of at least a transmission or connection established on the first radio resource or with the first communication signal source according to the downlink control information corresponding to the first radio resource or communication signal source.

A method for enhancing power control mechanism for a network device in a wireless communications system is disclosed. The method includes generating downlink control information corresponding to the mobile device for power control, transmitting the downlink control information to the mobile device without data conveying of a relay when the network device is a base station deployed with the relay capable of conveying data between the base station and the mobile device and the mobile device is under control of the base station and under radio wave coverage of the relay, and transmitting the downlink control information to the mobile device when the network device is the relay and the mobile device is under control of the base station or the relay.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 is a schematic diagram of an examplary wireless communications system.

FIG. 2 is a schematic diagram of an examplary communication device.

FIG. 3 is a schematic diagram of examplary program code of the communication device according to FIG. 2.

FIG. 4-9 are flowcharts of examplary processes.

### DETAILED DESCRIPTION

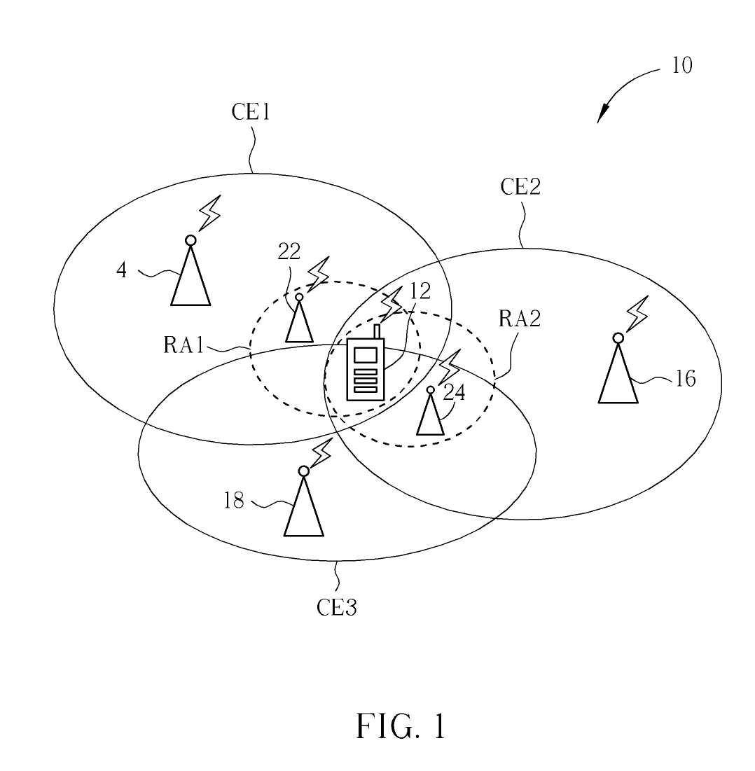

Please refer to FIG. 1, which is a schematic diagram of an examplary wireless communications system 10 (e.g. long term evolution-advanced (LTE-A) system) supporting relay deployment, coordinated multiple point (CoMP) transmission and simultaneous transmission/reception on multiple carriers (e.g. carrier aggregation). For convenience of explaining the concept of the disclosure, the wireless communications system 10 is illustrated to simply include a mobile device 12, and base stations 14-18 controlling cells CE1-CE3. The base stations 14, 16 are deployed with relays 22, 24 having coverages RA1, RA2, respectively. In the LTE-A system, the base stations 14-18 and the relays 22, 24 can be regarded as part of a network, i.e. E-UTRAN (evolved-UTRAN), comprising a plurality of eNBs (evolved Node-Bs) each controlling a cell, whereas the mobile device 12 is referred as to a user equipments (UE) that can be devices such as mobile phones, portable computer systems, etc. This terminology will be used throughout the application for ease of reference, and however, this should not be construed as limiting the disclosure to anyone particular type of network. In the wireless communications system 10, a uplink (UL) transmission can represent a UE-to-relay, UE-to-base station or relay-to-base station transmission, whereas a downlink transmission can represent a relay-to-UE, base station-to-UE or base station-to-relay transmission.

When the mobile device 12 is under the coverages RA1, RA2 of the relays 22, 24, the mobile device 12 can receive radio wave signals emitted by the relays 22, 24. When the mobile device 12 is under control of a base station/relay, this means that the mobile device 12 is configured based on the control signals from the base station/relay, not just meaning that the mobile device 12 is under the coverage of the base station/relay. The relays 22, 24 is capable of conveying/forwarding data between the mobile device 12 and the base stations 14, 16, respectively, and may be able to generate their own control signal to control connections between the mobile device 12 and the relays 22, 24. When the relay 22/24 is a transparent relay, the mobile device 12 is not aware of existence of the relay 22/24 and considers that all downlink or uplink transmissions are direct transmissions with the base station 14/16. When the relay 22/24 is a non-transparent relay, the mobile device 12 is aware of existence of the relay 22/24 and knows whether the downlink or uplink transmissions are performed via the relay 22/24 with the base station 14/16. In addition, the relay 22/24 and the base station 14/16 may include a physical cell identity (PCI) that is assigned to a cell controlled by the relay 22/24 or the base station 14/16. The PCI is a layer 1 radio signature. If the relay 22/24 has a PCI, the coverage RA1/RA2 can be seen as cell coverage, not jus radio wave coverage. When the PCI of the relay 22/24 or the base station 14/16 is different from other cells surrounding the mobile device 12 or from all cells of the network (e.g. the E-UTRAN), the PCI is considered a separated PCI. The cells (of the base stations 14-18 and/or the relays 22-24) may cooperate to perform a coordinated multiple point (CoMP) operation that is well known in the art.

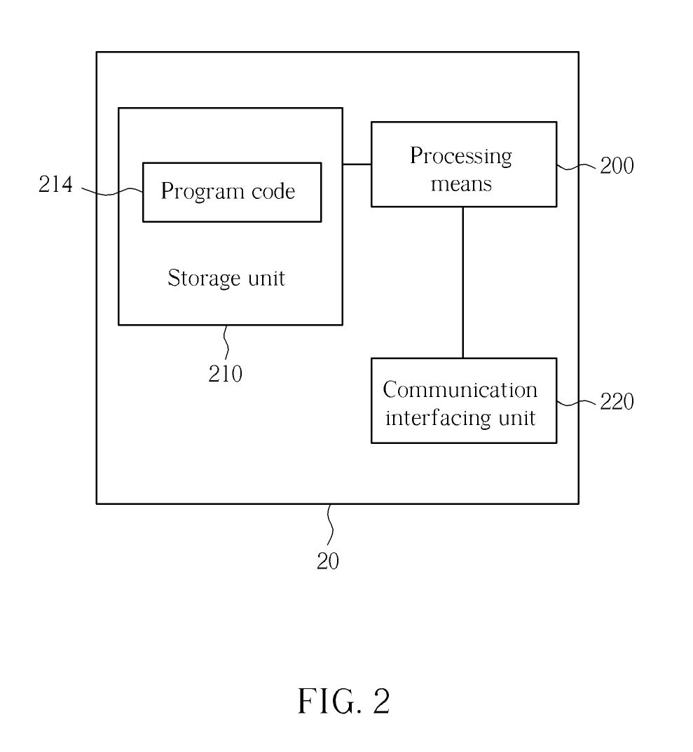

Please refer to FIG. 2, which illustrates a schematic diagram of an examplary communication device 20. The communication device 20 may be the mobile device 12, the base stations 14/16/18 or the relay 22/24 shown in FIG. 1 and include a processing means 200 such as a microprocessor or ASIC (Application-Specific Integrated Circuit), a memory unit 210 and a communication interfacing unit 220. The memory unit 210 may be any data storage device that can store program code 214 for access by the processing means 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 may be a radio transceiver and accordingly exchanges wireless signals with other communication devices according to processing results of the processing means 200. In addition, the communication interfacing unit 220 may include multiple antennas for performing a multiple-input/multiple-output (MIMO) function and/or the CoMP operation.

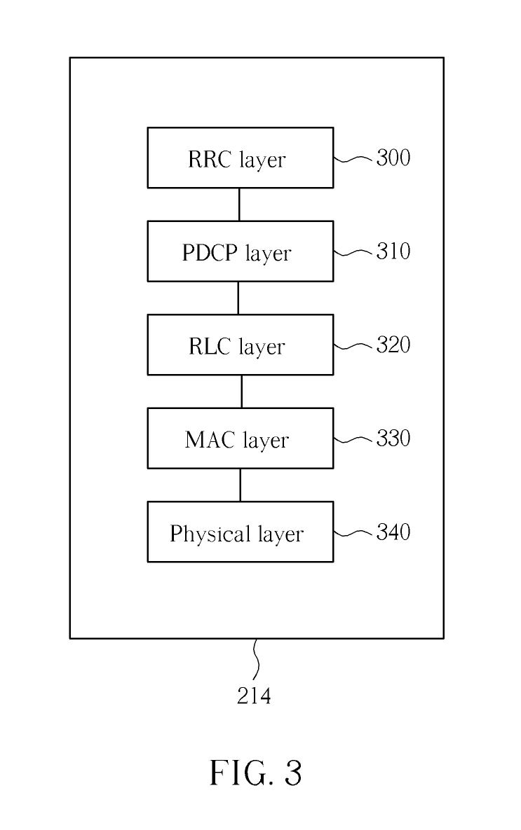

Please refer to FIG. 3, which illustrates a schematic diagram of examplary program code 214 for the communication device 20 used as the UE of the LTE-A system. The program code 214 includes program code of multiple communications protocol layers, which from top to bottom are a radio resource control (RRC) layer 300, a packet data convergence protocol (PDCP) layer 310, a radio link control (RLC) layer 320, a medium access control (MAC) layer 330 and a physical (PHY) layer 340. The RRC layer 300 functions to control one or more RRC connections with one or more relays/base stations/cells/access points as access nodes in the network based on RRC configuration that may be originally stored in the memory unit 210, self-generated or received from the relay(s)/base station(s)/cell(s)/access point(s). The RLC layer 320 controls more or one radio link corresponding to the RRC connection(s). The MAC layer 330 can performs handle hybrid automatic repeat request (HARQ) processes to transmit/receive MAC packets. The MAC layer 330 feedbacks an acknowledgement (ACK) to the network if a MAC packet is successfully received and decoded or feedbacks a negative acknowledgement (NACK) if the MAC packet is failed in reception or decoding. The PHY layer 340 can monitor a physical downlink control channel (PDCCH) for receiving control information for a downlink or uplink transmission, a physical downlink shared channel (PDSCH) for receiving data packet/messages, a physical uplink shared channel (PUSCH) for transmitting the data packet/messages. The control information received via the PDCCH may be regarded as downlink control information hereinafter. The PHY layer 340 operates with subframe/component carrier. The PHY layer 340 may perform carrier aggregation to simultaneously transmitting/receiving radio signals from one or more relays/base stations/cells/access points via multiple component carriers. In addition, the PHY layer 340 can perform power control for the component carriers based on the downlink control information that may include a transmission power control (TPC) command and further include an uplink grant (e.g. PUSCH related information) and/or a downlink assignment (e.g. PDSCH related information) and/or a modulation and coding scheme (MCS) and/or hybrid automatic repeat request (HARQ) information and/or a relay indication and/or CoMP information. An ACK/NACK repetition can be performed at the PHY layer 340, using consecutive subframes for repeatedly transmitting an ACK (or NACK), whereas the PHY layer 340 without enabled ACK/NACK repetition can only transmit the ACK/NACK in one subframe.

For convenience of explaining the concept of the disclosure, communication signal sources are provide hereinafter, seen as antenna ports, cells, relays or base stations of the network, access points (e.g. active cells in CoMP operation) of the UE, or any others that can independently provide the UE with radio signals. And radio resources are provided hereinafter, seen as component carriers, resource blocks, or spatial domain resources.

First, the UE in the wireless communications system 10 shall not transmit any other UL signal (e.g. PUSCH) including any ACK/NACK response corresponding to a detected PDSCH transmission during the ACK/NACK repetition period corresponding to another detected PDSCH transmission. Consequently, if the UE has detected a PDCCH signaling indicating an UL grant as well as a TPC command in UL, and the corresponding PUSCH collides with the ACK/NACK repetition corresponding to a detected PDSCH transmission, any PUSCH signaling cannot be transmitted.

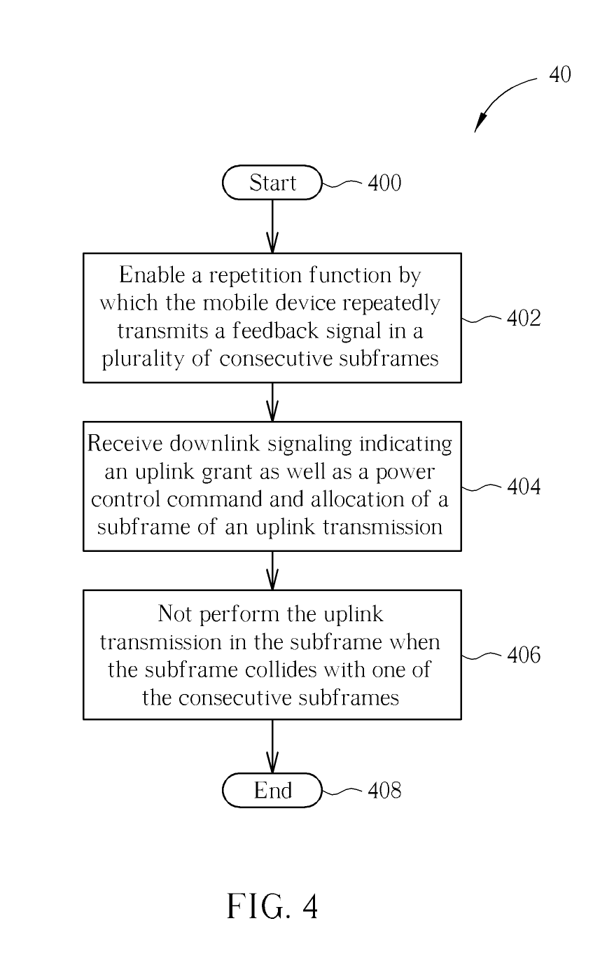

Please refer to FIG. 4, which is a flowchart of an examplary process 40 for enhancing power control mechanism for a UE (e.g. the mobile device 12 in FIG. 1) in a wireless communications system. The process 40 may be compiled into the program code 214 and includes the following steps:

Step 400: Start.

Step 402: Enable a repetition function by which the mobile device repeatedly transmits a feedback signal in a plurality of consecutive subframes.

Step 404: Receive downlink signaling indicating an uplink grant as well as a power control command and allocation of a subframe of an uplink transmission.

Step 406: Not perform the uplink transmission in the subframe when the subframe collides with one of the consecutive subframes.

Step 408: End.

According to the process 40, the UE having enabled the repetition function receives the downlink signaling associated the uplink transmission that the UE is requested to perform by the network. The downlink signaling indicates both uplink grant and power control command, and the subframe of receiving downlink signaling implies the UL subframe where the UL grant is applied. In this situation, the UE does not perform the uplink transmission in a subframe indicated by the downlink signaling and related power control when the subframe collides with one of the consecutive subframes where the UE needs to repeatedly transmit the feedback signal.

Take an example associated with the LTE system. The E-UTRAN sends PDCCH signaling as well as a UL grant to the UE and the UL grant contains a TPC command for UL transmission of a PUSCH. When the UE having enabled an ACK/NACK repetition detects the PDCCH signaling and the opportunity for the UL transmission collides with a subframe within a transmission period of the ACK/NACK repetition (e.g.ACK/NACK shall be provided and may be transmitted on PUCCH) of a detected PDSCH (e.g. intended to the UE), the UL transmission of the PUSCH is not performed. The UE applies the TPC command of the UL grant for power control to comply with the network that considers, even though the UL transmission is not performed, that the UE will perform a following uplink transmission base on the TPC command. Further, the UE may increment a transmission counter by one. The UE may select a redundancy version (RV) for next transmission opportunity of a retransmission on PUSCH or for next reception opportunity from PUSCH for retransmission, according to the incremented transmission counter and/or an adaptive retransmission indication of the PDCCH signaling (e.g. modulation and coding scheme or a redundancy version). The RV indicates a starting point in a circular buffer of the UE to start reading out bits. Different RVs are specified by defining different starting points to enable HARQ operation. Accordingly, even though the UL transmission of the UE is not performed, the network may also increment a transmission counter of the network its own by one and then perform the retransmission of the UE according to the transmission counter or an adaptive retransmission indication. In this situation, the following redundancy versions of the next uplink transmission/retransmission used by the UE and the network can be the same. Thus, data soft combining error of the network can be avoided.

In the abovementioned example, the UE not performing the UL transmission may alternatively not apply the TPC command for power control and/or the transmission counter may not be incremented by one. That is, the TPC command is ignored and the transmission counter remains its original value. Accordingly, the network may still consider that the TPC command is applied at the UE and/or that the transmission counter is incremented by one at the UE even though the PUSCH is not transmitted (e.g. not expected). In this situation, the UE may still select the redundancy version in the same way as mentioned above. In addition, the uplink transmission opportunity (e.g. UL grant) can be used for transmitting ACK/NACK of the detected PDSCH or for transmitting a specific signal (e.g. a reference signal such as sounding reference signal).

Take another example associated with the LTE system. The UE having enabled an ACK/NACK repetition performs a detected PDSCH transmission in subframe {n−4}, and thereby needs to report an ACK or NACK to the E-UTRAN. The corresponding ACK/NACK responses need to be transmitted on a PUCCH in subframes {n, n+1, . . . , n+N_{ANREP}−1}. The period of the subframes {n, n+1, . . . , n+N_{ANREP}−1} are regarded as a ACK/NACK repetition period. Then, the UE receives PDCCH signaling indicating a PUSCH transmission opportunity. When the UE needs to transmit the ACK/NACK and the PUSCH uplink data (s) on the same antenna port or in the same subframe of the ACK/NACK repetition period, the UE ignores the subframe allocation of the PDCCH signaling and further determines that the PDCCH signaling indicates control information for a specific purpose, not for the uplink transmission associated with the ACK/NACK repetition (e.g. for transmission/connection control to other antenna ports/cells/access points, instead of for the colliding PUSCH). For example, the UE may determine that a TPC command/UL grant/adaptive (re) transmission information of the PDCCH signaling is used for UL transmission to an antenna port/cell/access point/component carrier other than the antenna port/cell/access point/component carrier used for the ACK/NACK transmission. The PDCCH signaling may be of new DCI (downlink control information) format compared to the DCI format 0/1/2/3 of the LTE system. Further, the PDCCH signaling may include indication of cell information (e.g. information indicating a target cell) and/or relay information (e.g. information indicating a relay) and/or CoMP information (e.g. information indicating CoMP operation).

In the abovementioned example, the UE may receive at least one set of PDCCH signaling in sequence (e.g. 3 in sequence in 3 subframes), and at least one set of PDCCH is (are) associated to at least one PUSCH transmission opportunity (opportunities) in sequence. When the at least one PUSCH transmission opportunity (opportunities) in sequence collide(s) with the ACK/NACK repetition period (e.g. all collisions in the same ACK/NACK repetition period, or some collisions in current ACK/NACK repetition and some collisions in the next ACK/NACK repetition), the UE determines that the specific purpose of the at least one PDCCH(s) in sequence is (are) used for transmission (or connection) control to other antenna port(s) or cell(s) or access point(s) in sequence (e.g. in sequence relationship to a list of antenna port(s) or cell(s) or access point(s)) instead of for the colliding PUSCH transmission opportunity (opportunities).

For example, assume an ACK/NACK repetition period is 4-subframe long. The UE has detected a PDSCH transmission at a subframe {n−4} and thereby needs to transmit ACKs/NACKs at subframes {n, n+1, n+2 and n+3}. If multiple sets of PDCCH signaling have been detected by the UE at subframes {n−3, n−2, n−1}, and the CoMP operation involves cells CE1-CE4 (cell CE1 is serving donor cell), this means that the PUSCH transmission corresponding to the sets of PDCCH signaling need to be performed at subframes {n+1, n+2, n+3}. In this situation, the sets of PDCCH signaling are determined to be used for specific purpose (e.g. UL power control, UL grant, an adaptive retransmission and UL transmission) and used for the cells CE2-CE4 respectively.

To sum up, the examples of the process 40 provide a way of applying configuration for power control and related redundancy version without performing corresponding uplink transmission when the uplink transmission collides with an feedback repetition period to avoid soft decoding error at the network, a way of determining that downlink control information associated with power control is not used for the uplink transmission colliding with an feedback repetition period but for other purpose to avoid radio resource waste.

Secondly, the UE in the wireless communications system 10 may transmit/receive multiple transmissions from more than one access point, (e.g. cells CE1-CE3 in CoMP operation) or even both relay(s) and base station(s) together. The disclosure provides the following mechanism to deal with UL power control of the UE with connections to multiple geographically separated antenna ports, access points or cells where channel conditions (e.g. an interference level) and distances are different among cells (e.g. pathloss characteristics, cell coverage, power control parameters, and interference control are all different among cells). With relay deployment, the UE may transmit to or receive from both the base station(s) and the relay(s). When the relay is non-transparent to the UE (e.g. the relay has a relay indication or a separated PCI), the operating situation is similar to a CoMP operation with two cells (i.e. the cells of the base station and the deployed relay).

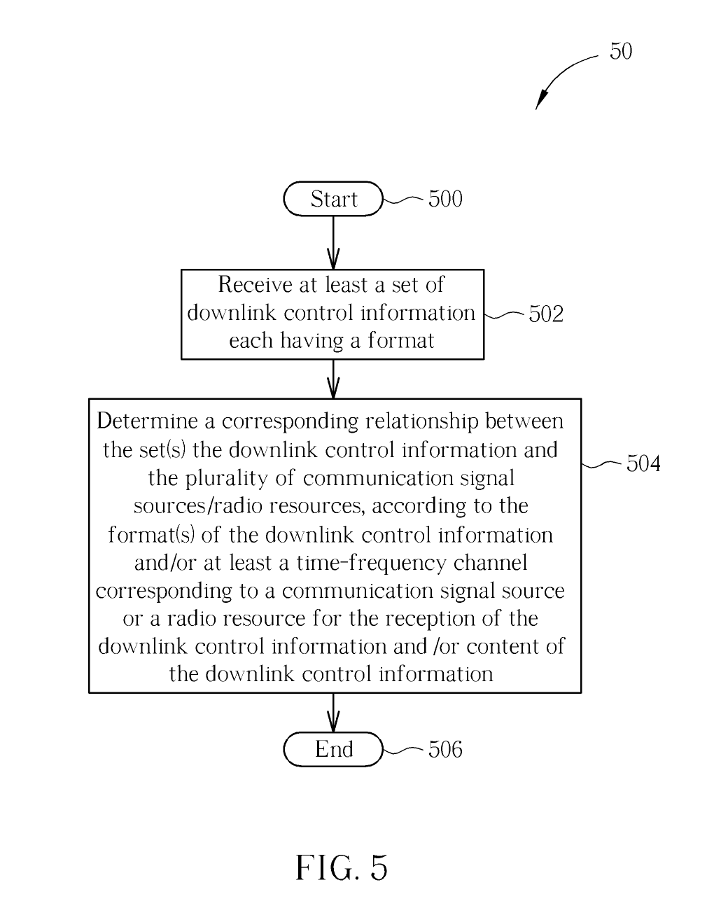

Please refer to FIG. 5, which is a flowchart of an examplary process 50 for enhancing power control mechanism for a UE (e.g. the mobile device 12 in FIG. 1) capable of simultaneously communicating through multiple radio resources or with multiple communication signal sources in a wireless communications system. The process 50 may be compiled into the program code 214 and includes the following steps:

Step 500: Start.

Step 502: Receive at least a set of downlink control information each having a format.

Step 504: Determine a corresponding relationship between the set(s) the downlink control information and the plurality of communication signal sources/radio resources, according to the format(s) of the downlink control information and/or at least a time-frequency channel corresponding to a communication signal source or a radio resource for the reception of the downlink control information and/or content of the downlink control information.

Step 506: End.

According to the process 50, the UE may be set with various possible formats and receive multiple sets of downlink control information from different communication signal sources (e.g. antenna ports) or on different radio resources (e.g. component carriers). Each received set of downlink control information is made by the network with a specific format that may be one of the DCIs 0/1/2/3 of the LTE system. The formats of the sets of downlink control information may be the same or different. The UE then may determine the corresponding relationship according to the format and/or the time-frequency channel and/or content of the downlink control information. The UE may further adjust transmission power of connection(s) established with each communication signal sources or on each of the radio resources according to corresponding downlink control information. In the process 50, the UE may needs to perform blind decoding to find out which format the network uses for each set of downlink control information.

Furthermore, the UE may determine a type of one of the communication signal sources, according to corresponding format or corresponding content part of the downlink control information. The communication signal sources may be antenna ports, cells relays or base stations of a network of the wireless communications system, access points of the network or components carriers. The downlink control information may include a TPC command and further include an uplink grant and/or a downlink assignment and/or a modulation and coding scheme (MCS) and/or hybrid automatic repeat request (HARQ) information and/or a relay indication and/or CoMP information.

Take a UE capable of transmission with multiple antenna ports, cells, access points or component carriers (e.g. a UE of the LTE_A system) for example. The antenna ports, cells, access points can transmit their sets of DL control signaling (e.g. PDCCH signaling) with multiple different formats (e.g. DCI formats). When the UE receives the sets of DL control signaling from the antenna ports/cells/access points or via multiple component carriers, the UE determines that the set of DL control signaling with a first format is used to indicate transmission/reception control information related to a first antenna port, cell, access point (e.g. a base station) or component carrier. Further, the UE determines that the set of DL control signaling with a second format is used to indicate transmission/reception control information related to a second antenna port, cell, access point (e.g. a relay, or one of active cells in CoMP operation) or component carrier, and so on. In other words, the UE may determine that the sets of DL control signaling according to the formats for different antenna ports, cells, access points or component carriers. The formats may be DCI format 0 and DCI format 3/3A. The first format and the second format may be the same, whereas the time-frequency channels of the downlink control information with the first and second formats are different. In this situation, the UE may determine the corresponding relationship according to the time-frequency channels.

In addition, the transmission/reception control information may include a TPC command, and/or UL grant, and/or downlink assignment, and/or MCS, and/or HARQ information, and/or relay indication (e.g. relay identity), and/or CoMP information (e.g. information indicating to which active cell the UE needs to perform transmission). In this situation, the UE may determine the corresponding relationship according to the content of the transmission/reception control information.

In the abovementioned example, assume that the first antenna port, cell, access point or component carrier corresponds to a base station (e.g. donor serving base station or cell). In this situation, when the second antenna port, cell or access point corresponds to a relay, the relay may be transparent, considered as a port from the base station. The relay may also have ability to send the DL control signaling (e.g. PDCCH signaling for scheduling), and/or with a physical cell identity whose usage is well known in the art. Alternatively, the relay may be non-transparent, and/or have ability to send the DL control signaling (e.g. PDCCH for scheduling), and/or with the physical cell identity. When the second antenna port, cell, access point or component carrier corresponds to one of active cells in CoMP operation, the DL control signaling with corresponding format is intended according to sequence of reception corresponding to the active cells in a list (e.g. take turns) of the UE. For example, the UE has a list of active cells ACE1-ACE5, and receives sets of DL control signaling with formats FMT1-FMT5. According to the DL control signaling with the formats FMT2, the UE knows that the corresponding antenna port, cell, access point or component carrier corresponds to the active cell ACE2. In this situation, the UE then may use the sets of DL control signaling with formats FMT3-FMT5 for the active cells ACE3-ACE5, respectively.

Take another example. The network and the UE can different formats predefined to correspond to antenna ports, cells, access points or component carriers accessed by the UE. The network can transmit DL control signaling only with one format type. When a UE receives the DL control signaling with certain format, the UE knows that the DL control signaling indicates control information for power control (e.g. TPC command of power control of transmission/reception) for a certain antenna port, cell, access point (e.g. an active cell in CoMP operation or a relay node) or component carrier. The UE may further apply the control information for transmission or reception of the certain antenna port, cell, access point or component carrier. The DL control signaling may be received only from a donor antenna port, a serving cell or a dominant access point. In addition, the UE may determines whether the control information indicated by the DL control signaling is used for an active cell in CoMP operation or a relay, according to the format or other information in the DL control signaling (e.g. indication explicitly indicating which cell, which antenna port, or whether the control information is for a relay or a base station, or a mapping by value or bitmap).

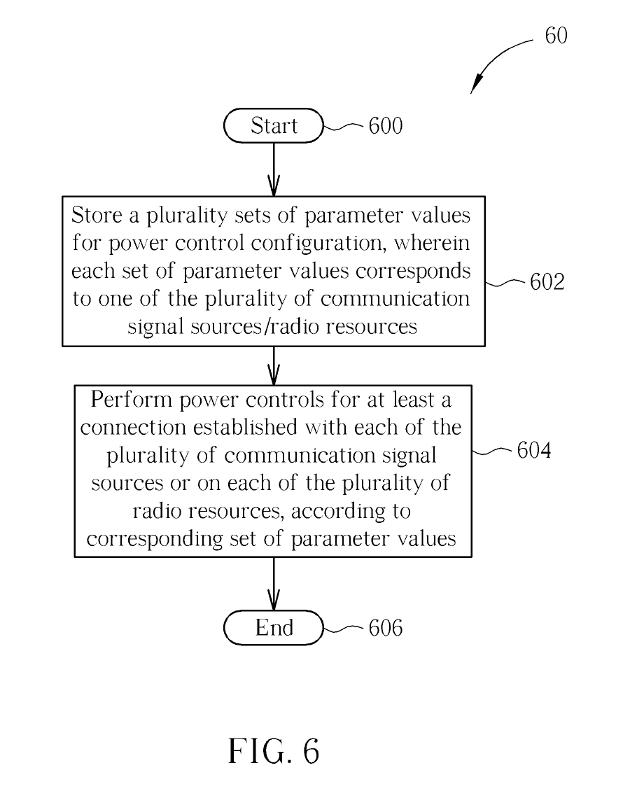

Please refer to FIG. 6, which is a flowchart of an examplary process 60 for enhancing power control mechanism for a UE (e.g. the mobile device 12 in FIG. 1) capable of simultaneously communicating through multiple radio resources or with multiple communication signal sources in a wireless communications system. The process 60 may be compiled into the program code 214 and includes the following steps:

Step 600: Start.

Step 602: Store a plurality sets of parameter values for power control configuration, wherein each set of parameter values corresponds to one of the plurality of communication signal sources/radio resources.

Step 604: Perform power controls for at least a connection established with each of the plurality of communication signal sources or on each of the plurality of radio resources, according to corresponding set of parameter values.

Step 606: End.

According to the process 60, the UE stores a set of parameter values as predefined power control configuration (e.g. predefined or configured power control parameters, such as δ_{PUSCH} used in the LTE system) for each communication signal source. When the UE needs to control the transmission power of one or more connections established with anyone of the communication signal sources or via multiple radio resources, the UE applies corresponding set of stored parameter values. For example, when the UE increases/decreases transmission power corresponding to a dominant communication signal source (e.g. a donor cell, a serving base station) or a dominant radio resource (e.g. a component carrier corresponding to the donor cell) according to corresponding set of parameter values, the UE may increase/decrease all transmission powers corresponding to the rest of communication signal sources/radio resources according to corresponding sets of parameter values. In other words, transmission powers corresponding to all of the communication signal sources/radio resources are controlled in the same trend. Or, the sets of parameter values may include a TPC command and all the TPC command are the same, so that the UE performs the power control of the all of the communication signal sources/radio resources in the same way. Accordingly, the base stations and/or relays holding the connections knows the same predefined parameter values and thereby can perform appropriate power control for the following transmissions of the connections.

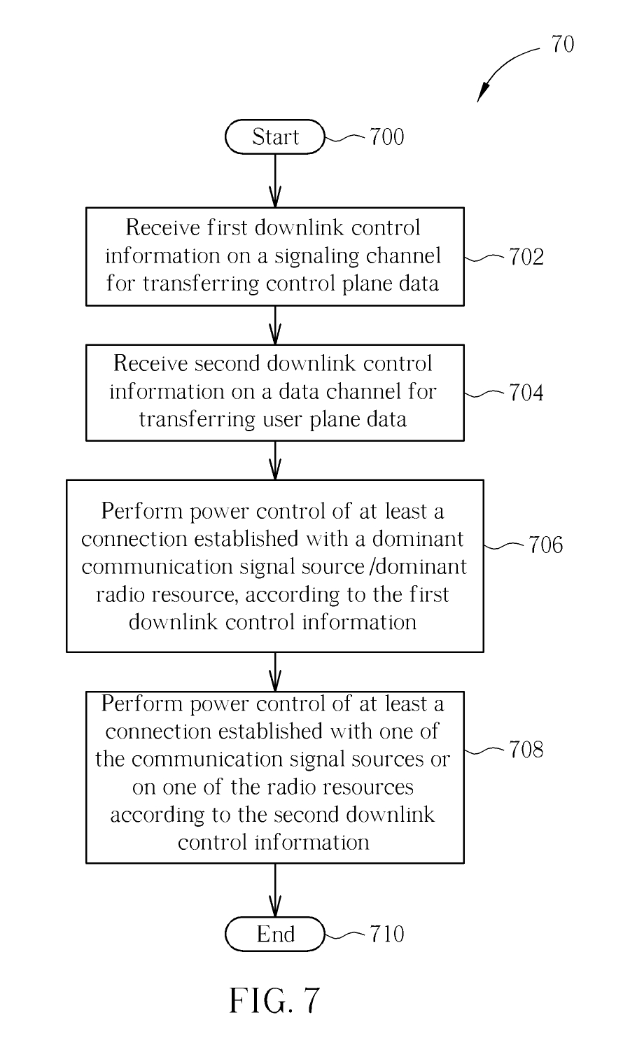

Please refer to FIG. 7, which is a flowchart of an examplary process 70 for enhancing power control mechanism for a UE (e.g. the mobile device 12 in FIG. 1) capable of simultaneously communicating through multiple radio resources or with multiple communication signal sources in a wireless communications system. The process 70 may be compiled into the program code 214 and includes the following steps:

Step 700: Start.

Step 702: Receive first downlink control information on a signaling channel for transferring control plane data.

Step 704: Receive second downlink control information on a data channel for transferring user plane data.

Step 706: Perform power control of at least a connection established with a dominant communication signal source/dominant radio resource, according to the first downlink control information.

Step 708: Perform power control of at least a connection established with one of the communication signal sources or on one of the radio resources according to the second downlink control information.

Step 710: End.

According to the process 70, the UE can receive downlink control information on both the signaling and data channels. Then, the UE performs the power control of one or more connections established with the dominant communication signal source, according to the downlink control information received from the signaling channel. In addition, the UE performs the power control of one or more connections established with any one of communication signal sources/radio resources, according to the downlink control information received from the data channel.

For example, with deployment/configuration of multiple antenna ports, cells, access points or component carriers, the UE may apply downlink control information of PDCCH signaling received from a donor antenna port, an antenna port, a serving cell, an access point/component carrier for transmission/reception related to the donor antenna port, serving cell or access point. In addition, the UE may apply control information of a message received via a PDSCH from any of the antenna port, cells, access points or component carriers, which is preferably an antenna port, cell or access point other than the donor/serving one. The control information of the message may be identified or handled at the MAC or PHY layer of the UE. For example, the message may be constructed by the network as a MAC packet having a MAC payload and a MAC header that includes a control information indication (e.g. indication for power control, UL grant, DL assignment, MCS). The UE may obtain the downlink control information from the MAC payload according to the control information indication of the MAC header. Or, the downlink control information may be indicated by the MCS or a reference signal during processing of the PHY layer.

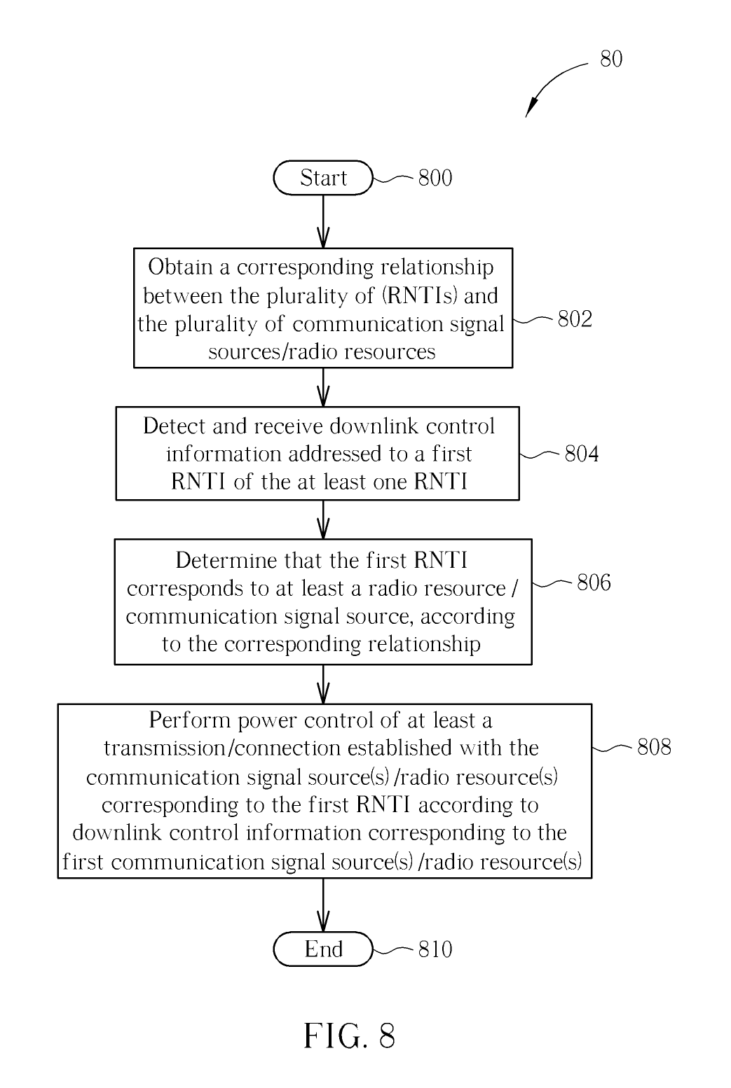

Please refer to FIG. 8, which is a flowchart of an examplary process 80 for enhancing power control mechanism for a UE (e.g. the mobile device 12 in FIG. 1) capable of simultaneously communicating through multiple radio resources or with multiple communication signal sources in a wireless communications system, where the UE is configured by the network with a plurality of radio network temporary identifiers (RNTIs). The process 80 may be compiled into the program code 214 and includes the following steps:

Step 800: Start.

Step 802: Obtain a corresponding relationship between the plurality of (RNTIs) and the plurality of communication signal sources/radio resources.

Step 804: Detect and receive downlink control information addressed to a first RNTI of the at least one RNTI.

Step 806: Determine that the first RNTI corresponds to at least a radio resource/communication signal source, according to the corresponding relationship.

Step 808: Perform power control of at least a transmission/connection established with the communication signal source(s)/radio resource(s) corresponding to the first RNTI according to downlink control information corresponding to the first communication signal source(s)/radio resource(s).

Step 810: End.

According to the process 80, the UE with the corresponding relationship detects and receives downlink control information addressed to the first RNTI and further determines that the first RNTI corresponds to radio resource (s)/communication signal source(s). Then, the UE may perform the power control of one or more connections established with radio resource(s)/communication signal source(s) corresponding to the first RNTI according to the received downlink control information. The downlink control information for power control corresponding to the communication signal sources/radio resources may be configured with the same or different content.

Ways to obtain the corresponding relationship are described below. The network only configures to the UE one RNTI that is automatically used by the UE to correspond to all radio resources/communication signal sources. Or, the network configures to the UE not only multiple RNTIs but also the corresponding relationship. Or, the UE stores a table/list about the corresponding relationship.

The network may perform a cyclic redundancy check (CRC) scrambling with the first RNTI when transmitting corresponding downlink control information to the UE. Accordingly, the UE determines that the downlink control information is for the UE its own, when the UE finds that the first RNTI, one of the RNTIs, works on decoding (e.g. CRC check) of the downlink control information.

In addition, the UE may receive from network configuration and thereby set up at least one transmission power control index (TPC index) corresponding to the radio resources/communication signal sources. In this situation, the UE may obtain at least a power control command from the downlink control information according to the TPC index(es). Then, the UE may perform the power control of the at least a transmission/connection established on the first radio resource (s) or with the first communication signal source(s) according to the obtained power control command(s).

For example, when the UE is configured to operate with three component carriers, the UE may be configured with one RNTI and three TPC indexes thereof. When the downlink control information is detected, the UE applies the TPC indexes to find three power control commands corresponding to the configured component carriers, respectively. Alternatively, the UE may be configured with three RNTIs each corresponding to a TPC index and a component carrier. When the downlink control information is detected on a first one of the component carriers, the UE applies corresponding TPC index to obtain a power control commands corresponding to the first component carrier.

The RNTIs may include at least one of a cell RNTI (C-RNTI), a transmission power control PUSCH-RNTI (TPC-PUSCH-RNTI), and a TPC-PUCCH-RNTI. With deployment/configuration of multiple antenna ports, cells, access points or component carriers, the UE may receive sets of PDCCH signaling addressed to the UE with the RNTIS that are configured by network for different antenna ports, cells, access points or component carriers. If one of the antenna ports, cells, access points or component carriers is a relay or an active cell in CoMP operation, the C-RNTI and/or TPC-PUSCH-RNTI and/or TPC-PUCCH-RNTI can be configured for the UE to monitor PDCCH signaling corresponding to the relay (e.g. transmission/reception to/from the relay node) or the active cell. The relay may be non-transparent or transparent, and/or with ability to send PDCCH signaling for scheduling, and/or with a physical cell identity (PCI).

Please note that the concept of the process 80 is not limited to RNTIs, and other definable indications can also be used for the UE to receive power control configuration for different communication signal sources/radio resources. In addition, the concepts of the processes 50 and 80 can be combined for the UE to receive downlink control information for a specific communication signal source/radio resource.

To sum up, the examples of the processes 50-80 provides a way of distinguishing which communication signal source(s)/radio resource(s) the received downlink control information associated with power control corresponds to according to the format(s) of the received downlink control information and/or the RNTIs of the UE.

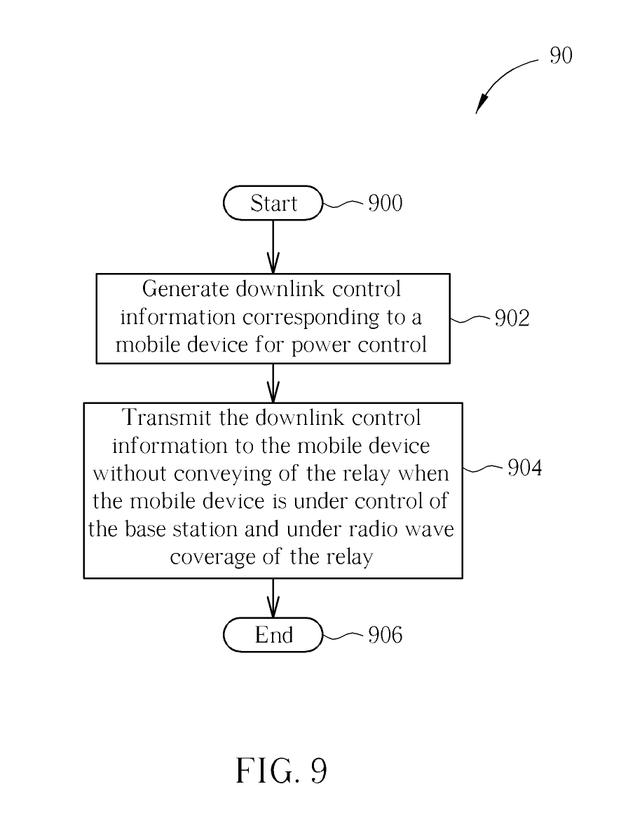

Please refer to FIG. 9, which is a flowchart of an examplary process 90 for enhancing power control mechanism for a base station (e.g. the base station 14/16/18 in FIG. 1) in a wireless communications system. The process 90 may be compiled into the program code 214 and includes the following steps:

Step 900: Start.

Step 902: Generate downlink control information corresponding to a mobile device for power control.

Step 904: Transmit the downlink control information to the mobile device without conveying of the relay when the mobile device is under control of the base station and under radio wave coverage of the relay.

Step 906: End.

According to the process 90, the mobile device is directly controlled by the base station, and the relay plays a role of conveying data and is not allowed to generate its own control signal for connection(s) with the mobile device. In this situation, the base station directly transmits the downlink control information to the mobile device without assistance of the relay when the mobile device is under radio wave coverage of the relay.

The base station may decide or realize whether the UE is under coverage of a relay or is under control of the relay. In addition to the process 90, some other solutions are provided as below. The relay that is transparent or non-transparent to the UE may transmit or forward the PDCCH signaling generated by the base station to the UE. For example, the relay may utilize a prescheduled PDCCH transmission for transmitting the PDCCH signaling or snoop a PDCCH transmission of the base station and then forward the PDCCH signaling. Or the relay may transmit PDCCH signaling generated by the relay itself to the UE.

Accordingly, the UE may apply downlink control information of the received PDCCH signaling for power control of the transmission corresponding to the PDCCH signaling no matter whether the PDCCH signaling is received from the relay node or the base station. The UE may consider that the PDCCH signaling is always sent by the base station even though the PDCCH signaling is actually used for transmission/reception to/from the relay. In addition, when the UE under the radio wave coverage of the relay node knows that it is controlled by the relay, the UE may consider that all PDCCH signalings needs to be applied for its transmission/reception occurred within the coverage of the relay node. For example, the UE may consider that all PDCCH signalings are received from the relay node and then just apply them when the UE is under coverage or under control of the relay.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method for enhancing power control mechanism for a mobile device in a wireless communications system, the method comprising:
enabling a repetition function by which the mobile device repeatedly transmits a feedback signal in a plurality of consecutive subframes;
receiving first downlink signaling indicating an uplink grant as well as a power control command and allocation of a first subframe of a first uplink transmission; and
not performing the first uplink transmission in the first subframe when the first subframe collides with one of the consecutive subframes.

2. The method of claim 1 further comprising at least one of:
adjusting transmission power according to the power control command; and
incrementing a transmission counter of a redundancy version corresponding to a starting point of a buffer which the mobile device uses to decode received data; or
further comprising at least one of:
ignoring the power control command; and
remaining the value of the transmission counter of the redundancy version.

3. The method of claim 2 further comprising at least one of:
performing a retransmission of the first uplink transmission according to the redundancy version with the transmission counter value or adaptive retransmission indication; and
performing a downlink reception corresponding to the retransmission according to the redundancy version with the transmission counter value.

4. The method of claim 1 further comprising:
using an opportunity of the first uplink transmission for transmitting at least a feedback signal or for transmitting a reference signal or an uplink signal.

5. The method of claim 1 further comprising at least one of:
determining that the first downlink signaling is not used for the first uplink transmission; and
determining that the first downlink signaling is used to indicate control information for a first purpose.

6. The method of claim 5, wherein the first purpose is a purpose of transmission or connection control to an antenna port, a cell, an access point or a component carrier that is not associated with a transmission or connection corresponding to the first subframe.

7. The method of claim 6 further comprising:
determining that the first downlink signaling indicates the power control command for a second uplink transmission to the antenna port, cell or access point or the component carrier that is not associated with the transmission or connection corresponding to the first subframe; or
determining that the first downlink signaling indicates adaptive transmission information or retransmission information for the second uplink transmission.

8. The method of claim 6 further comprising at least one of:
receiving second downlink signaling indicating a second subframe of a third uplink transmission after the first downlink signaling is received;
when the second subframe collides with one of the consecutive subframes or later consecutive subframes of the repetition function, determining that the first purpose and a second purpose of using the second downlink signaling are for transmission or connection control to at least an antenna port, a cell, an access point or a component carrier that is not associated with a transmission or connection corresponding to the first subframe; and
using the first downlink signaling for a first antenna port, a first cell, a first access point or a first component carrier and the second downlink signaling for a second antenna port, a second cell, a second access point or a second component carrier according to a list of the mobile device, wherein the list includes the first antenna port and the second antenna port in sequence, the first cell and the second cell in sequence, the first access point and the second access point in sequence, or the first component carrier and the second component carrier in sequence;
wherein the first and second antenna ports, the first and second cells, the first and second access points or the first and second component carriers are the antenna ports, cells, access points or component carriers that is not associated with a transmission or connection corresponding to the first subframe, respectively.

9. The method of claim 5, wherein the first downlink signaling is of a downlink control information (DCI) format different from a DCI 0, DCI 1, DCI 2, DCI 3 of a long term evolution system when the wireless communications system is the long term evolution system; or
wherein the first downlink signaling includes indication of at least one of cell information, relay information and coordinated multiple point (CoMP) information.

10. A method for enhancing power control mechanism for a network in a wireless communications system, the method comprising:
sending to a mobile device downlink signaling indicating an uplink grant as well as a power control command and allocation of a subframe of a first uplink transmission; and
determining that the mobile device applies the power control command, when the first uplink transmission is not performed in the subframe.

11. The method of claim 10 further comprising:
determining that the mobile device increments a transmission counter of redundancy version of the mobile device, when the first uplink transmission is not performed in the subframe; and
performing a second uplink transmission corresponding to an uplink retransmission of the mobile device according to the transmission counter of redundancy version or adaptive retransmission indication, wherein the second uplink transmission is an uplink transmission next to the first uplink transmission.

12. A method for enhancing power control mechanism for a mobile device capable of simultaneously communicating through a plurality of radio resources or with a plurality of communication signal sources in a wireless communications system, the method comprising:
receiving at least a set of downlink control information each having a format; and
determining a corresponding relationship between the at least a set of downlink control information and the plurality of radio resources or between the at least a set of downlink control information and the plurality of communication signal sources, according to at least one of corresponding format, at least a time-frequency channel corresponding to a communication signal source or a radio resource for the reception of the downlink control information, and content of the downlink control information.

13. The method of claim 12, wherein receiving the at least a set of downlink control information each having a format comprises receiving the sets of downlink control information each having a format through some of the plurality of radio resources or with some of the plurality of communication signal sources; and determining the corresponding relationship between the downlink control information and the plurality of radio resources or between the downlink control information and the plurality of communication signal sources according to at least one of corresponding format, the at least a time-frequency channel, and the content of the downlink control information comprises:
determining that the set of downlink control information with a first format or a first time-frequency channel corresponds to a first radio resource or a first communication signal source and that the set of downlink control information with a second format or a second time-frequency channel corresponds to a second radio resource or a second communication signal source.

14. The method of claim 13 further comprising at least one of:
adjusting transmission power of a first connection established with the first radio resource or the first radio communication signal source according to the downlink control information with the first format or the first time-frequency channel; and
adjusting transmission power of a second connection established with the second radio resource or the second radio communication signal source according to the downlink control information with the second format or the second time-frequency channel.

15. The method of claim 13, wherein receiving at least a set of downlink control information each having a format comprises:
receiving the downlink control information with the second format from a relay that is transparent to the mobile device, has ability to send the downlink control information, or has a physical cell identity; or
receiving the downlink control information with the second format from a relay that is non-transparent to the mobile device, has the ability to send the downlink control information, or has the physical cell identity;
wherein the first radio resource or the first radio communication signal source is a base station deployed with the relay.

16. The method of claim 13 further comprising:
determining a type of a first one of the plurality of radio resources or of the plurality of communication signal sources, according to the format that is determined to correspond to the first radio resource or the first communication signal source, the time-frequency channel corresponding to the first radio resource or the first communication signal source or content of the downlink control information.

17. The method of claim 12, wherein receiving the at least a set of downlink control information each having a format comprises at least one of:
receiving the downlink control information from a communication signal source that is a donor antenna port, a serving cell or an access point that dominates the rest of the access points associated with the mobile device; or
receiving the downlink control information from a radio resource that is an anchor radio resource that dominates the rest of the radio resources configured for the mobile device.

18. The method of claim 12, wherein the plurality of communication signal sources are antenna ports, cells relays or base stations of a network of the wireless communications system, access points of the network or components carriers; and the plurality of radio resources are component carriers, resource blocks, or spatial domain resources; and the downlink control information includes a transmission power control command or includes the transmission power control command and at least one of an uplink grant, a downlink assignment, a modulation and coding scheme, hybrid automatic repeat request information, a relay indication and coordinated multiple point (CoMP) information.

19. A method for enhancing power control mechanism for a mobile device capable of simultaneously communicating through a plurality of radio resources or with a plurality of communication signal sources in a wireless communications system, the method comprising:
storing a plurality sets of parameter values for power control configuration, wherein each set of parameter values corresponds to one of the plurality of radio resources or the plurality of communication signal sources; and
performing power control for at least a connection established with each of the plurality of communication signal sources or on each of the plurality of radio resources, according to corresponding set of parameter values.

20. The method of claim 19, wherein performing the power control for at least a connection established with each of the plurality of communication signal sources or on each of the plurality of radio resources according to corresponding set of parameter values comprises:
when transmission power corresponding to a dominant communication signal source dominating the rest of communication signal sources or to a dominant radio resource dominating the rest of radio resources is increased, increasing all transmission powers corresponding to the rest of communication signal sources or radio resources; and
when the transmission power corresponding to the dominant communication signal source or radio resource is decreased, decreasing all transmission powers corresponding to the rest of communication signal sources or radio resources.

21. The method of claim 19, wherein the plurality of communication signal sources are antenna ports, cells or base stations of a network of the wireless communications system, access points of the network or components carriers; wherein the plurality of radio resources are component carriers, resource blocks, or spatial domain resources.

22. A method for enhancing power control mechanism for a mobile device capable of simultaneously communicating through a plurality of radio resources or with a plurality of communication signal sources in a wireless communications system, the method comprising:
receiving first downlink control information on a signaling channel for transferring control plane data;
receiving second downlink control information on a data channel for transferring user plane data;
performing power control of at least a connection established with a dominant communication signal source dominating the rest of communication signal sources or on a radio resource dominating the rest of radio resources, according to the first downlink control information; and
performing power control of at least a connection established with one of the communication signal sources or on one of the radio resources according to the second downlink control information.

23. The method of claim 22, wherein receiving the second downlink control information on the data channel comprises:
receiving a message including the second downlink control information on the data channel;
identifying and obtaining the second downlink control information by handling at a medium access control (MAC) layer or a physical layer of the mobile device;
identifying the second downlink control information according to a modulation and coding scheme (MCS) or a reference signal when the physical layer is utilized to identify and obtain the second downlink control information; and
identifying the second downlink control information according to a MAC packet including a MAC header and a MAC payload when the MAC layer is utilized to identify and obtain the second downlink control information, wherein the MAC header includes a control information, corresponding to the second downlink control information, indication for at least one of power control, a uplink grant, downlink assignment and the MCS, and the MAC payload includes the second downlink control information corresponding to the control information indication of the MACK header.

24. A method for enhancing power control mechanism for a mobile device capable of simultaneously communicating through a plurality of radio resources or with a plurality of communication signal sources in a wireless communications system, the method comprising:
obtaining a corresponding relationship between at least one radio network temporary identifier (RNTI) and the plurality of radio resources or between the at least one RNTI and the plurality of communication signal sources;
detecting and receiving downlink control information addressed to a first RNTI of the at least one RNTI;
determining that the first RNTI of the at least one RNTI corresponds to at least a first radio resource or communication signal source of the plurality of radio resources or communication signal sources, according to the corresponding relationship; and
performing power control of at least a transmission or at least a connection established on the at least a first radio resource or with the at least a first communication signal source according to the received downlink control information corresponding to the at least a first radio resource or the at least a first communication signal source.

25. The method of claim 24 further comprising:
receiving configuration for configuring the mobile device to set up at least one transmission power control index (TPC index) corresponding to the plurality of radio resources or to the plurality of communication signal sources;
obtaining at least a power control command from the downlink control information according to the at least one TPC index; and
wherein performing the power control of the at least a transmission or at least a connection established on the at least a first radio resource or with the at least a first communication signal source according to the received downlink control information addressed to the first RNTI comprises performing the power control of the at least a transmission or at least a connection established on the a least a first radio resource or with the at least a first communication signal source according to the at least a obtained power control command.

26. The method of claim 24, wherein the plurality of communication signal sources are antenna ports, cells or base stations of a network of the wireless communications system, access points of the network or components carriers; and the plurality of radio resources are component carriers, resource blocks, or spatial domain resources.

27. The method of claim 24, wherein obtaining the corresponding relationship between the at least one RNTI and the plurality of radio resources or between the at least one RNTI and the plurality of communication signal sources comprises:
obtaining the corresponding relationship where at least one of a cell-RNTI, a transmission power control physical uplink shared channel RNTI (TPC-PUSCH-RNTI) and a transmission power control physical uplink control channel RNTI (TPC-PUUCH-RNTI) corresponds to a relay or a coordinated multiple point (CoMP) cell.

28. A method for enhancing power control mechanism for a mobile device capable of simultaneously communicating through a plurality of radio resources or with a plurality of communication signal sources in a wireless communications system, the method comprising:
obtaining a corresponding relationship between a plurality of radio network temporary identifiers (RNTIs) and the plurality of radio resources or between the plurality of RNTIs and the plurality of communication signal sources;
detecting and receiving downlink control information addressed to a first RNTI;
determining that the first RNTI corresponds to a first radio resource or communication signal source, according to the corresponding relationship; and
performing power control of at least a transmission or connection established on the first radio resource or with the first communication signal source according to the downlink control information corresponding to the first radio resource or communication signal source.

29. The method of claim 28, wherein obtaining the corresponding relationship between the plurality of radio network temporary identifiers (RNTIs) and the plurality of radio resources or between the plurality of RNTIs and the plurality of communication signal sources comprises:
obtaining the corresponding relationship where at least one of a cell-RNTI, a transmission power control physical uplink shared channel RNTI (TPC-PUSCH-RNTI) and a transmission power control physical uplink control channel RNTI (TPC-PUUCH-RNTI) corresponds to a relay when one of the plurality of communication signal sources is the relay; or
obtaining the corresponding relationship where at least one of a cell-RNTI, a transmission power control physical uplink shared channel RNTI (TPC-PUSCH-RNTI) and a transmission power control physical uplink control channel RNTI (TPC-PUUCH-RNTI) corresponds to a coordinated multiple point (CoMP) cell when one of the plurality of communication signal sources is the CoMP cell.

30. The method of claim 28 wherein the downlink control information is addressed by an identity.

31. A method for enhancing power control mechanism for a network device in a wireless communications system, the method comprising:
generating downlink control information corresponding to the mobile device for power control;
transmitting the downlink control information to the mobile device without data conveying of a relay when the network device is a base station deployed with the relay capable of conveying data between the base station and the mobile device and the mobile device is under control of the base station and under radio wave coverage of the relay; and
transmitting the downlink control information to the mobile device when the network device is the relay and the mobile device is under control of the base station or the relay.
